(19) United States
(12) Patent Application Publication
(10) Pub. No.: US 2024/0182043 A1
(43) Pub. Date: Jun. 6, 2024

(54) SYSTEM AND METHOD FOR ONBOARD VEHICLE CENTER OF GRAVITY AND MOMENT OF INERTIA ESTIMATION

(71) Applicant: STEERING SOLUTIONS IP HOLDING CORPORATION, Saginaw, MI (US)

(72) Inventors: Arash H. Ahangarnejad, Ferndale, MI (US); Peter D. Schmitt, Farmington Hills, MI (US)

(21) Appl. No.: 18/075,595

(22) Filed: Dec. 6, 2022

(51) Int. Cl. B60W 40/13

(52) U.S. Cl. CPC B60W 40/13; B60W 2520/105; B60W 2540/049

(57) ABSTRACT

A method for vehicle mass estimation includes setting a vehicle mass value to an initial value and a driving resistance force value to an initial value, receiving at least a longitudinal acceleration value, driving/braking torque on each axle/wheel, and an angular wheel velocity value, and estimating a driving resistance force value based on the vehicle mass value and the angular wheel velocity value. The method also includes setting the driving resistance force value to the estimated driving resistance force value and determining a fuel level value and a seat occupancy value for at least one seat of an associated vehicle. The method also includes estimating, using the fuel level value and the seat occupancy value, a vehicle load value, and setting, based on the vehicle load value, at least one of a center of gravity value of the vehicle and a moment of inertia value of the vehicle.

### TECHNICAL FIELD

This disclosure relates to determining a vehicle's center of gravity and moment of inertia, and in particular to systems and methods for improving the performance of active chassis systems.

### BACKGROUND

Vehicles, such as cars, trucks, sport utility vehicles, crossovers, mini-vans, all-terrain vehicles, recreational vehicles, or other suitable vehicles, include various systems, such as a steering system (e.g., an electronic power steering (EPS) system, a steer-by-wire steering (SbW) system, a hydraulic steering system, or other suitable steering systems), a vehicle propulsion system, and the like. During the operation of the vehicle, various controllers control aspects of vehicle operations based on decisions made using various data. Such control decisions may be improved using estimated vehicle parameters, such as the vehicle mass and rolling forces. Accurate estimation of the vehicle mass is crucial as the vehicle mass may vary depending on a vehicle load. Additionally, changes in the vehicle mass change the center of gravity location (e.g., fore-aft, lateral, and vertical), and may also change the roll, pitch, and yaw moments of inertia of the vehicle. Changes to such mass parameters may highly affect vehicle dynamics behavior.

### SUMMARY

This disclosure relates generally to using estimated mass and other control area network (CAN) information such as seat belt occupancy and fuel level to update the moment of inertia and center of gravity location, leading to improved estimates of the vehicle's other parameters and states.

An aspect of the disclosed embodiments includes a method for vehicle mass estimation. The method includes setting a vehicle mass value to an initial value and a driving resistance force value to an initial value, receiving at least a longitudinal acceleration value and an angular wheel velocity value, and estimating, in response to the longitudinal acceleration value being less than a threshold, the driving resistance force value based on the estimated vehicle mass value, driving/braking torque on each wheel/axle, and the angular wheel velocity value. The method also includes setting the driving resistance force value to the estimated driving resistance force value, and in response to a determination that the vehicle mass value is convergent, determining a fuel level value and a seat occupancy value for at least one seat of an associated vehicle. The method also includes estimating, using the fuel level value and the seat occupancy value, a vehicle load value, and setting, based on the vehicle load value, at least one of a center of gravity value of the vehicle and a moment of inertia value of the vehicle.

Another aspect of the disclosed embodiments includes a system for vehicle mass estimation. The system includes a processor and a memory. The memory includes instructions that, when executed by the processor, cause the processor to: set a vehicle mass value to an initial value and a driving resistance force value to an initial value; receive at least a longitudinal acceleration value driving/braking torque on each axle/wheel, and an angular wheel velocity value; estimate, in response to the longitudinal acceleration value being less than a threshold, a driving resistance force value based on the vehicle mass value and the angular wheel velocity value; set the driving resistance force value to the estimated driving resistance force value; in response to a determination that the vehicle mass value is convergent, determine a fuel level value and a seat occupancy value for at least one seat of an associated vehicle; estimate, using the fuel level value and the seat occupancy value, a vehicle load value; and set, based on the vehicle load value, at least one of a center of gravity value of the vehicle and a moment of inertia value of the vehicle.

Another aspect of the disclosed embodiments includes an apparatus for vehicle mass estimation. The apparatus includes a processor and a memory. The memory includes instructions that, when executed by the processor, cause the processor to: set a vehicle mass value to an initial value and a driving resistance force value to an initial value; receive at least a longitudinal acceleration value, driving/braking torque on each axle/wheel, and an angular wheel velocity value; in response to the longitudinal acceleration value being less than a threshold: estimate a driving resistance force value based on the vehicle mass value and the angular wheel velocity value; set the driving resistance force value to the estimated driving resistance force value; in response to a determination that the vehicle mass value is convergent, determine a fuel level value and a seat occupancy value for at least one seat of an associated vehicle; estimate, using the fuel level value and the seat occupancy value, a vehicle load value; and set, based on the vehicle load value, at least one of a center of gravity value of the vehicle and a moment of inertia value of the vehicle; in response to a determination that the longitudinal acceleration value is greater than the threshold and in response to the longitudinal acceleration value being within an acceleration range: estimate a vehicle mass value based on the estimated driving resistance force value and set the vehicle mass value to the estimated vehicle mass value; in response to a determination that the vehicle mass value is convergent, determine the fuel level value and the seat occupancy value for at least one seat of the associated vehicle; and estimate, using the fuel level value and the seat occupancy value, the vehicle load value; and selectively control at least one aspect of a vehicle system of the vehicle using at the at least one of the center of gravity value of the vehicle and the moment of inertia value of the vehicle.

These and other aspects of the present disclosure are provided in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 generally illustrates a vehicle according to the principles of the present disclosure.

FIG. 2 generally illustrates a vehicle dynamics estimation system according to the principles of the present disclosure.

FIG. 3 is a flow diagram generally illustrating a method for estimating moment of inertia and center of gravity data according to the principles of the present disclosure.

FIG. 4 is a flow diagram generally illustrating a method for estimating moment of inertia and center of gravity data according to the principles of the present disclosure.

FIG. 5 is a flow diagram generally illustrating the iterative nature related to updating multiple estimates according to the principles of the present disclosure.

FIGS. 6A and 6B generally illustrate a vehicle operating environment and vehicle dynamics according to the principle of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, vehicles, such as cars, trucks, sport utility vehicles, crossovers, mini-vans, all-terrain vehicles, recreational vehicles, or other suitable vehicles, include various systems, such as a steering system (e.g., an electronic power steering (EPS) system, a steer-by-wire steering (SbW) system, a hydraulic steering system, or other suitable steering systems), a vehicle propulsion system, and the like. During the operation of the vehicle, various controllers control aspects of vehicle operations based on decisions made using various data. Such control decisions may be improved using estimated vehicle parameters, such as the vehicle mass and rolling forces. Accurate estimation of the vehicle mass is crucial as the vehicle mass may vary depending on a vehicle load. Additionally, changes in the vehicle mass change the center of gravity location (e.g., fore-aft, lateral, and vertical), and may also change the roll, pitch, and yaw moments of inertia of the vehicle. Changes to such mass parameters may highly affect vehicle dynamics behavior.

Various model-based methods for simultaneous estimation of vehicle mass and road grade have been proposed in recent years. However, typical mass estimation methods do not account for the center of gravity location and moment of inertia estimation, which causes severe problems in vehicle dynamics behavior. One such approach includes a sensor-based method, where a time-varying grade is typically estimated using sensor data from an accelerometer or GPS receiver. A parameter estimation algorithm may be utilized for the estimation of the mass. However, the disadvantage of the sensor-based method is the cost and added complexity of extra sensors. Another alternative includes a model-based method that uses existing signals from the vehicle controller area network (CAN), which may be a less resource-intensive alternative to the sensor-based method. Standard signals such as driving and brake torques and wheel angular velocities are used in a model based-estimator.

Various model-based methods for simultaneous estimation of vehicle mass and road grade have been recently proposed. For example, a method for simultaneous estimation of mass and time-varying grade using a recursive least square (RLS) method. In particular, since standard RLS with a single forgetting factor could not estimate a constant mass and time-varying grades, an RLS with multiple forgetting factors may be used. With both simulated and some test data, incorporating two distinct forgetting factors could effectively resolve the difficulties in simultaneously estimating mass and time-varying grades.

Another approach is the two-stage Lyapunov-based estimation approach, which combines an RLS strategy for mass estimation and a nonlinear Lyapunov-based strategy for grade estimation. Based on the vehicle longitudinal dynamic model, a least-squares estimator may be used, which may determine an estimate of the vehicle mass and a constant estimate of the road grade. Also, due to the time-varying nature of the road grade, a nonlinear estimator may be used to provide a more accurate estimate of the road grade. However, such mass estimation methods do not cover the center of gravity (CG) location and moment of inertia estimation, which may cause severe problems in vehicle dynamics behavior.

Accordingly, systems and methods, such as those described herein, are configured to use estimated mass and other CAN information such as seat belt occupancy and fuel level to update the moment of inertia and CG location, leading to improved estimates of the other parameters and states of a vehicle, may be desirable. The systems and methods described herein may be configured to calculate vehicle mass estimation and update CG location and moments of inertia based on estimated mass and available vehicle onboard sensors.

The systems and methods described herein may be configured to model vehicle longitudinal dynamics. The systems and methods described herein may be configured to create an estimation equation group from the vehicle longitudinal dynamics equation. The estimation equation group may include wheel angular speed, driving torque, braking torque, longitudinal acceleration, other suitable information, or a combination thereof as input parameters. Vehicle mass properties and driving resistance of the vehicle may be estimated.

The systems and methods described herein may be configured to collect the wheel angular speed, the driving torque, the braking torque, and/or the longitudinal acceleration of the vehicle when the vehicle is running (e.g., in operation), during acceleration, braking, or other suitable operating states of the vehicle. The systems and methods described herein may be configured to estimate current vehicle mass value and driving resistance in different bandwidths using the recursive least square method iteratively until the current vehicle mass estimate is convergent.

The systems and methods described herein may be configured to, in response to the longitudinal acceleration being less than a predetermined threshold, estimate the driving resistance force. The systems and methods described herein may be configured to, in response to the longitudinal acceleration being greater than a predetermined threshold and within the activation range, estimate the vehicle mass by using the estimated driving resistance force.

The systems and methods described herein may be configured to, in response to the longitudinal acceleration being within a predetermined range, estimate the vehicle mass based on onboard sensors and the estimated driving resistance force. This two-step approach may be used because the driving resistance force estimate uses a default initial value for the mass. The systems and methods described herein may be configured to, by performing the estimation at a very low longitudinal acceleration, reduce errors associated with using the initial value of mass. These thresholds may be tuned by performing numerous permutations and calculating the root mean square (RMS) of estimated mass and actual mass residual in order to find the optimal value for triggers.

The systems and methods described herein may be configured to use the estimated vehicle mass with other CAN messages such as seat belts and fuel level information to determine which seats are occupied in the vehicle by passengers.

The systems and methods described herein may be configured to, based on the occupancy of seats in the vehicle and load information, update the center of gravity location and moment of inertia based on a prepopulated lookup table. Once determined from the lookup table, the center of gravity and moment of inertia parameters will be used in other systems.

In some embodiments, the systems and methods described herein may be configured to set a vehicle mass value to an initial value and a driving resistance force value to an initial value. The systems and methods described herein may be configured to receive at least a longitudinal acceleration value, wheel torque, and an angular wheel velocity value. The systems and methods described herein may be configured to estimate, in response to the longitudinal acceleration value being less than a threshold, a driving resistance force value based on the vehicle mass value and the angular wheel velocity value. The systems and methods described herein may be configured to estimate the estimated driving resistance force value using a recursive least square function or other suitable function.

The systems and methods described herein may be configured to set the driving resistance force value to the estimated driving resistance force value. The systems and methods described herein may be configured to, in response to a determination that the vehicle mass value is convergent, determine a fuel level value and a seat occupancy value for at least one seat of an associated vehicle. For example, the systems and methods described herein may be configured to determine the seat occupancy value for at least one seat, which includes using data associated with at least one corresponding seatbelt sensor, data associated with at least one weight sensor, data associated with an image capturing device, and/or any other suitable data associated with any other suitable sensor or device. Additionally, or alternatively, the systems and methods described herein may be configured to determine the fuel level value using any suitable sensor or device associated with the fuel level of the vehicle.

The systems and methods described herein may be configured to estimate, using the fuel level value and the seat occupancy value, a vehicle load value. The systems and methods described herein may be configured to set, based on the vehicle load value, at least one center of gravity value of the vehicle, and a moment of inertia value of the vehicle.

In some embodiments, the systems and methods described herein may be configured to estimate, in response to a determination that the longitudinal acceleration value is greater than the threshold and in response to the longitudinal acceleration value being within an acceleration range, estimate a vehicle mass value based on the driving resistance force value. The systems and methods described herein may be configured to set the vehicle mass value to the estimated vehicle mass value.

The systems and methods described herein may be configured to, in response to a determination that the vehicle mass value is convergent, determine the fuel level value and the seat occupancy value for at least one seat of the associated vehicle. For example, the systems and methods described herein may be configured to estimate vehicle mass value using a recursive least square function or other suitable function. The systems and methods described herein may be configured to estimate, using the fuel level value and the seat occupancy value, the vehicle load value. For example, the systems and methods described herein may be configured to determine the seat occupancy value for at least one seat including using data associated with at least one corresponding seatbelt sensor, data associated with at least one weight sensor, data associated with an image capturing device, and/or any other suitable data associated with any other suitable sensor or device. Additionally, or alternatively, the systems and methods described herein may be configured to determine the fuel level value using any suitable sensor or device associated with the fuel level of the vehicle.

The systems and methods described herein may be configured to set, based on the vehicle load value, at least one of the center of gravity values of the vehicle, and the moment of inertia value of the vehicle. The systems and methods described herein may be configured to selectively control at least one aspect of a vehicle system of the vehicle using at least one of the center of gravity values of the vehicle and the moment of inertia value of the vehicle. The vehicle system may include one or more active chassis systems such as an anti-lock braking system, an electronic stability control system, an active suspension system, an active damping system, an active stabilizer bar system, any other suitable active chassis system, a steering system (e.g., such as an EPS steering system, an SbW steering system, or any other suitable steering system), and/or any other suitable vehicle system.

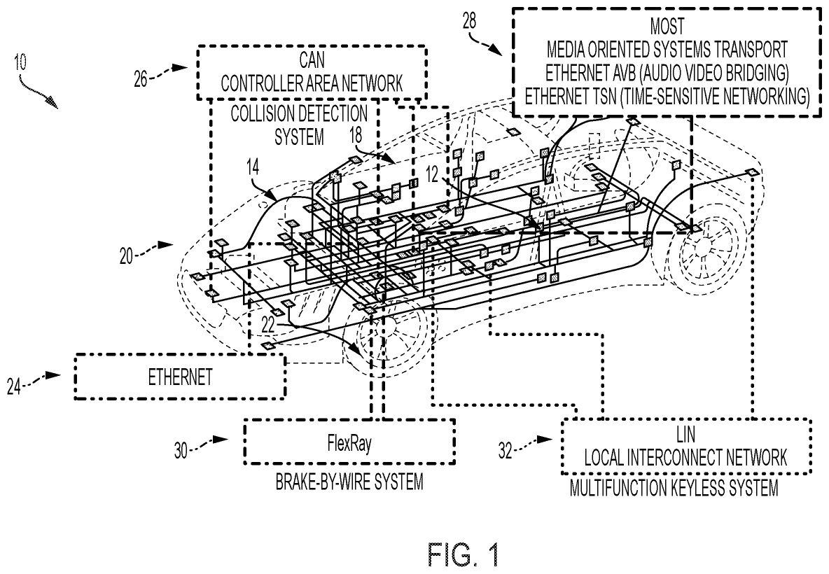

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be movably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed toward the rearward portion of vehicle 10 than is generally illustrated.

The passenger compartment 18 may be disposed of rearward of the engine compartment 20 but may be disposed forward of the engine compartment 20 in embodiments where the engine compartment 20 is disposed toward the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed toward the passenger compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provide energy to the electric motors to turn the wheels 22.

The vehicle 10 may include automatic vehicle propulsion systems, such as cruise control, adaptive cruise control, automatic braking control, other automatic vehicle propulsion systems, or a combination thereof. The vehicle 10 may be an autonomous or semi-autonomous vehicle or other suitable types of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connections between the handwheel and wheels 22 of the vehicle 10), a hydraulic steering system (e.g., which may include a magnetic actuator incorporated into a valve assembly of the hydraulic steering system), or other suitable steering systems.

The steering system may include an open-loop feedback control system or mechanism, a closed-loop feedback control system or mechanism, or a combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

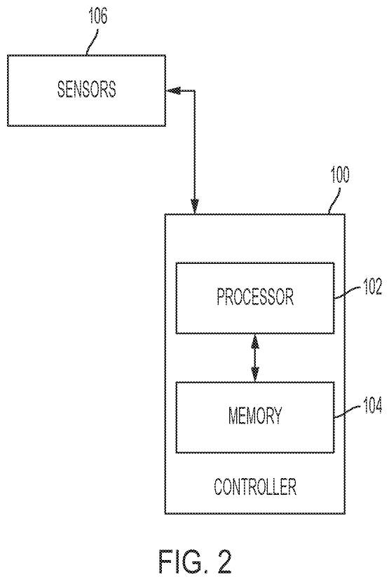

In some embodiments, the steering system may include a steering system controller, such as controller 100, as is generally illustrated in FIG. 2. The controller 100 may include any suitable controller. The controller 100 may be configured to control, for example, the various functions of the steering system. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid-state) memory, or the like. The memory 104 may include Random Access Memory (RAM), a Read-Only Memory (ROM), or a combination thereof. The memory 104 may include instructions that, when executed by the processor 102, cause the processor 102 to, at least, control various functions of the steering system and/or any other suitable function, including those of the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensors or devices, one or more motor angle sensors or devices, other suitable sensors, or devices, or a combination thereof. One or more signals may indicate a handwheel torque, a handwheel angel, a motor angle or motor position, a vehicle speed, other suitable information, or a combination thereof.

In some embodiments, the controller 100 may be configured to receive motor sensor data from at least one sensor 106. The motor sensor data may a plurality of motor angle measurements and respective time values (e.g., corresponding to an irregular sampling or execution rate). The controller 100 may determine an average time value based on the respective time values for each motor angle measurement. The controller 100 may generate a first gain value based on at least the average time value. The controller 100 may generate a second gain value based on at least the first gain value and the average time value.

The controller 100 may estimate a motor velocity based on at least one motor angle measurement, the average time value, the first gain value, the second gain value, and at least one previously estimated motor velocity. The controller 100 may estimate the motor velocity using a discrete transfer function based on at least one motor angle measurement, the average time value, the first gain value, the second gain value, and the at least one previously estimated motor velocity. The first gain value and/or the second gain value may be configured to reduce noise in the discrete transfer function.

In some embodiments, controller 100 may perform the methods described herein. However, the methods described herein as performed by controller 100 are not meant to be limiting, and any type of software executed on a controller or processor can perform the methods described herein without departing from the scope of this disclosure. For example, a controller, such as a processor executing software within a computing device, can perform the methods described herein.

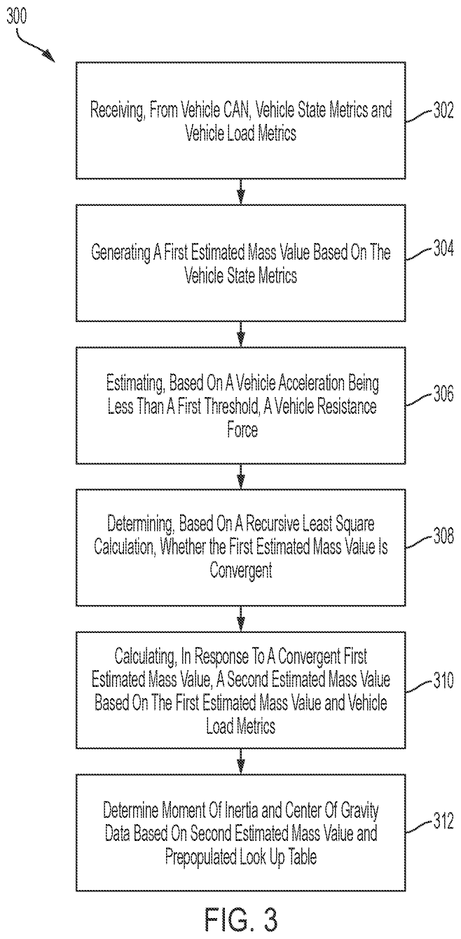

FIG. 3 is a block diagram illustrating a high-level overview of the vehicle metrics estimating process 300. At 302, the process 300 receives from the vehicle CAN, vehicle state metrics and vehicle load metrics. A vehicle CAN, also known as a CAN bus, allows the various devices in a vehicle to communicate with one another (e.g., sensors, and microcontrollers). The vehicle state metrics may include wheel angular speed, driving torque, braking torque, longitudinal acceleration, estimated mass vehicle properties, and driving resistance of the vehicle. The vehicle state metrics may be organized into a matrix or any suitable data structure. The vehicle load metrics may include vehicle occupancy, fuel level, seat belt usage, truck storage level, battery discharge level, and any data obtained related to vehicle weight through vehicle sensors.

At 304, the process 300 generates a first estimated mass value based on the vehicle state metrics. The first estimated mass value may be based on the nominal weight of the vehicle, which is based on the vehicle curb weight of the vehicle as defined by the production entity of the vehicle (e.g., also taking into consideration the option content of the vehicle by the production entity). At 306, the process 300 estimates a vehicle resistance force. The process 300 compares the longitudinal acceleration value and compares it to a predetermined threshold. The process 300 will estimate the vehicle resistance force when the longitudinal acceleration value is less than the predetermined threshold. At 308, the process 300 determines whether the first estimated mass value is convergent based on a recursive least square's calculation. A recursive least squares algorithm may recursively find the values that minimize the weighted linear least squares cost function related to the vehicle state metrics.

At 310, the process 300 calculates a second estimated mass value based on the first estimated mass value and vehicle load metrics in response to a convergent first estimated mass value. At 312, the process 300 determines the moment of inertia and center of gravity data based on the second estimated mass value and a prepopulated look-up table. The moment of inertia is a quantity that may determine the torque needed for a desired angular acceleration about a rotational axis. The moment of inertia may depend on the vehicle's mass distribution, with a larger moment requiring more torque to change the vehicle's rate of rotation. A prepopulated look-up table is unique to each vehicle. The content of the prepopulated lookup table is based on the part of vehicle characteristics. Vehicle characteristics may be obtained from the manufacturer of the vehicle.

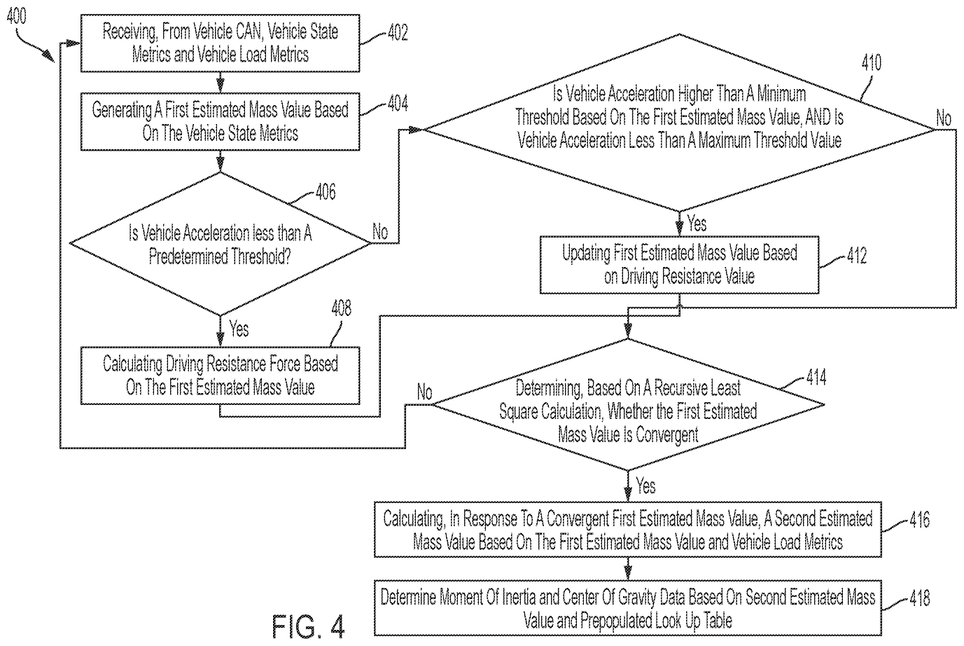

FIG. 4 is a block diagram illustrating a high-level overview of the vehicle metrics estimating process 400. At 402, the process 400 receives from the vehicle CAN, vehicle state metrics and vehicle load metrics. A vehicle CAN, also known as a CAN bus, allows the various devices in a vehicle to communicate with one another (e.g., sensors, and microcontrollers). The vehicle state metrics may include wheel angular speed, driving torque, braking torque, longitudinal acceleration, estimated mass vehicle properties, and driving resistance of the vehicle. The vehicle load metrics may include vehicle occupancy, fuel level, seat belt usage, truck storage level, battery discharge level, and any data obtained related to vehicle weight through vehicle sensors.

At 404, the process 400 generates a first estimated mass value based on the vehicle state metrics. At 406, the process 400 determines whether or not the vehicle acceleration is less than a predetermined threshold. If yes, the process 400 moves on to step 408, where the process 400 calculates the driving resistance force based on the estimated mass value. A driving resistance force may be the vector sum of numerous forces whose direction is opposite to the forward trajectory of the vehicle. However, if at 406, the process 400 determines the vehicle acceleration is not less than the predetermined threshold, the process 400 continues to 410.

At 410, the process 400 determines the vehicle longitudinal acceleration value. The process 400 compares the longitudinal acceleration value with the minimum and maximum thresholds. The process 400, the longitudinal acceleration is compared with the predetermined thresholds, and when it is greater than a minimum threshold (a.k.a., minimum longitudinal acceleration threshold), and the vehicle acceleration is less than a maximum threshold (a.k.a., maximum longitudinal acceleration threshold). If yes, the process 400, at 412, updates the mass value based on the estimated driving resistance value. In a scenario where process 400 has not estimated a driving resistance force, the latest value is used until an estimate is made at 408. However, when the vehicle acceleration is out of the range and it is less than the predetermined threshold for estimating resistance force, the process 400 continues to 414.

At 414, the process 400 determines whether the first estimated mass value is convergent, based on recursive least square calculation. When the first estimated mass value is not convergent, the process 400 returns to 402. When the first estimated mass value is convergent, the process 400 continues to 416.

At 416, the process 400 calculates a second estimated mass value based on the first estimated mass value and the vehicle load metrics received from the vehicle CAN. At 418, the process 400 determines the moment of inertia and center of gravity of the vehicle based on the second estimated mass value and the prepopulated lookup table. The moment of inertia is a quantity that may determine the torque needed for a desired angular acceleration about a rotational axis. The moment of inertia may depend on the vehicle's mass distribution, with a larger moment requiring more torque to change the vehicle's rate of rotation. A prepopulated look-up table is unique to each vehicle. The content of the prepopulated lookup table may be based in part on vehicle characteristics. Vehicle characteristics may be obtained from the manufacturer of the vehicle.

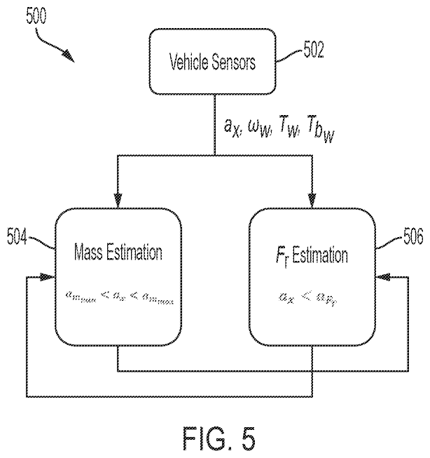

FIG. 5 is a block diagram directed toward the process 500 between the mass estimation 504 and the driving resistance force estimation 506. The vehicle sensors 502 may obtain data related to the vehicle state metrics and the vehicle load metrics. Based on the vehicle state metrics, the process 500 obtains a first estimated mass value for the vehicle. Whether 504 or 506 follows 502 depends on the vehicle's acceleration. An initial value may not be calculated for the driving resistance force until the circumstances of the vehicle acceleration allow for a calculation to take place. Until the vehicle acceleration allows for the calculation, a predetermined default initial value may be used, and when the vehicle acceleration condition is met, the resistance force may be updated.

The process 500 determines whether the vehicle acceleration is greater than a minimum threshold, and the vehicle acceleration is less than a maximum threshold. When the longitudinal acceleration value is within the range, the process 500, at 504, updates the mass value based on the estimated driving resistance value. The process 500 may determine whether or not the vehicle acceleration is less than a predetermined threshold for estimating driving resistance force. When the longitudinal acceleration is less than the predetermined threshold for estimating resistance force, the process 500 moves on to step 506, where the process 500 calculates the driving resistance force based on the latest estimated mass value.

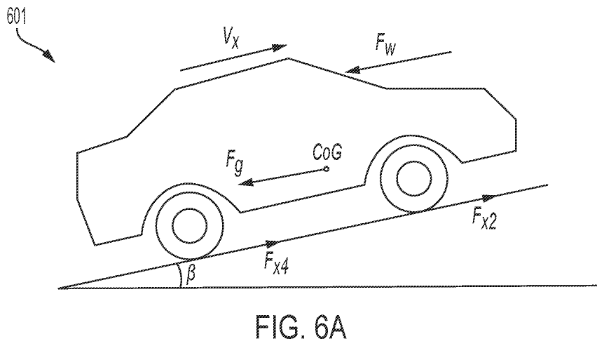

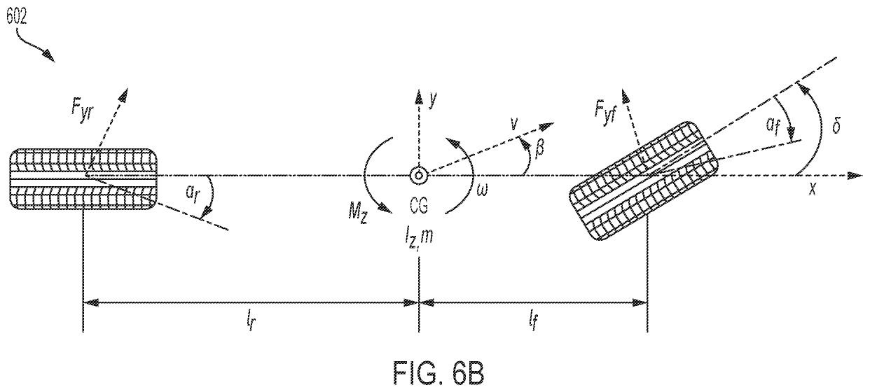

FIG. 6A is a visual example of the operating environment 601 illustrating the various forces acting upon the vehicle.

$${ma}_{{x}_{sensor}} = {\sum }_{i = 1}^{4} {F}_{{x}_{i}} - {F}_{r}$$

Fᵣ estimation when aₓ_{ₛₑₙₛₒᵣ}<aₓ_{_{low}}:

$$\{ \begin{matrix}θ = {\hat{F}}_{r} \\ y = \sum [ \frac{{T}_{i} - {I}_{w} {\dot{ω}}_{i}}{r} ] - \tilde{m} {a}_{{x}_{sensor}} \\ ϕ = 1\end{matrix}$$

m estimation when aₓ_{_{low}}<aₓ_{ₛₑₙₛₒᵣ}<aₓ_{_{high}}:

$$\{ \begin{matrix}θ = \hat{m} \\ y = \sum [ \frac{{T}_{i} - {I}_{w} {\dot{ω}}_{i}}{r} ] - {\tilde{F}}_{r} \\ ϕ = {a}_{{x}_{sensor}}\end{matrix}$$

y and ϕ correspond to the Output and Regressors inputs of the Recursive Least Squares Estimator block, respectively. θ corresponds to the Parameters outport.

FIG. 6B is bicycle model 602 visually displaying the different forces acting upon the vehicle. These forces are used in the following calculations:

$$\{ \begin{matrix}{ma}_{y} = {F}_{{y}_{f}} + {F}_{{y}_{r}} \\ {I}_{z} \dot{r} = {l}_{f} {F}_{{y}_{f}} - {l}_{r} {F}_{{y}_{r}}\end{matrix}$$

Vehicle longitudinal dynamics may be determined based on:

m\ddot{x}=F_{driving/braking}−mg sin θ−μᵣmg cos θ−F_{D}

m(\ddot{x}+g sin θ)=F_{driving/braking}−μᵣmg cos θ−F_{D}

maₓ_{ₛₑₙₛₒᵣ}=F_{driving/braking}−μᵣmg cos θ−F_{D}

maₓ_{ₛₑₙₛₒᵣ}=F_{driving/braking}−Fᵣ

Where m is vehicle mass (variable to be estimated), aₓ_{ₛₑₙₛₒᵣ} is vehicle longitudinal acceleration (received from a vehicle sensor), F_{driving/braking} is the sum of driving and braking force on all wheels (received as input), and Fᵣ is resistance force (variable to be estimated).

In some embodiments, the controller 100 may set a vehicle mass value to an initial value and a driving resistance force value to an initial value. The controller 100 may receive at least a longitudinal acceleration value and an angular wheel velocity value. The controller 100 may estimate, in response to the longitudinal acceleration value being less than a threshold, a driving resistance force value based on the vehicle mass value, driving/braking torque, and the angular wheel velocity value. The controller 100 may estimate the estimated driving resistance force value using a recursive least square function or other suitable function.

The controller 100 may set the driving resistance force value to the estimated driving resistance force value. The controller 100 may, in response to a determination that the vehicle mass value is convergent, determine a fuel level value and a seat occupancy value for at least one seat of vehicle 10. For example, the controller 100 may determine the seat occupancy value for at least one seat includes using data associated with at least one corresponding seatbelt sensor, data associated with at least one weight sensor, data associated with an image capturing device, one or more of the sensors 106, and/or any other suitable data associated with any other suitable sensor or device. Additionally, or alternatively, the controller 100 may determine the fuel level value using any suitable sensor or device associated with the fuel level of the vehicle 10.

The controller 100 may estimate, using the fuel level value and the seat occupancy value, a vehicle load value. The controller 100 may set, based on the vehicle load value, at least one of a center of gravity value of the vehicle 10 and a moment of inertia value of the vehicle 10.

In some embodiments, the controller 100 may estimate, in response to a determination that the longitudinal acceleration value is less than the predetermined threshold, a resistance force is generated. In response to the longitudinal acceleration, the value is greater than the minimum threshold, and being within an acceleration range, a vehicle mass value is estimated based, at least in part, on the latest driving resistance force value. The controller 100 may set the vehicle mass value to the estimated vehicle mass value.

The controller 100 may, in response to a determination that the vehicle mass value is convergent, determine the fuel level value and the seat occupancy value for at least one seat of the vehicle 10. For example, the controller 100 may estimate the vehicle mass value using a recursive least square function or other suitable function. The controller 100 may estimate, using the fuel level value and the seat occupancy value, the vehicle load value. The controller 100 may set, based on the vehicle load value, at least one of the center of gravity values of the vehicle 10, and the moment of inertia value of the vehicle 10. The controller 100 may selectively control at least one aspect of a vehicle system (e.g., such as those described herein) of the vehicle 10 or any other suitable feature, operation, aspect, or function of the vehicle 10 using at least one of the center of gravity values of the vehicle 10 and the moment of inertia value of the vehicle 10.

In some embodiments, a method for vehicle mass estimation includes setting a vehicle mass value to an initial value and a driving resistance force value to an initial value, receiving at least a longitudinal acceleration value and an angular wheel velocity value, and estimating, in response to the longitudinal acceleration value being less than a threshold, an estimated driving resistance force value based on the vehicle mass value and the angular wheel velocity value. The method also includes setting the driving resistance force value to the estimated driving resistance force value, and in response to a determination that the vehicle mass value is convergent, determining a fuel level value and a seat occupancy value for at least one seat of an associated vehicle. The method also includes estimating, using the fuel level value and the seat occupancy value, a vehicle load value, and setting, based on the vehicle load value, at least one of a center of gravity value of the vehicle and a moment of inertia value of the vehicle.

In some embodiments, estimating the driving resistance force value includes using a recursive least square function. In some embodiments, determining the seat occupancy value for at least one seat includes using data associated with at least one corresponding seatbelt sensor. In some embodiments, the method also includes estimating, in response to a determination that the longitudinal acceleration value is greater than the minimum threshold and in response to the longitudinal acceleration value being within an acceleration range, an vehicle mass value based on the estimated driving resistance force value and setting the vehicle mass value to the estimated vehicle mass value. In some embodiments, the method also includes, in response to a determination that the vehicle mass value is convergent, determining the fuel level value and the seat occupancy value for at least one seat of the associated vehicle. The method also includes estimating, using the fuel level value and the seat occupancy value, the vehicle load value. In some embodiments, the method also includes setting, based on the vehicle load value, at least one of the center of gravity values of the vehicle, and the moment of inertia value of the vehicle. In some embodiments, the estimated vehicle mass value includes using a recursive least square function. In some embodiments, determining the seat occupancy value for at least one seat includes using data associated with at least one corresponding seatbelt sensor. In some embodiments, the method also includes selectively controlling at least one aspect of a vehicle system of the vehicle using at least one of the center of gravity values of the vehicle and the moment of inertia value of the vehicle.

In some embodiments, a system for vehicle mass estimation includes a processor and a memory. The memory includes instructions that, when executed by the processor, cause the processor to set a vehicle mass value to an initial value and a driving resistance force value to an initial value; receive at least a longitudinal acceleration value and an angular wheel velocity value; estimate, in response to the longitudinal acceleration value being less than a threshold, an estimated driving resistance force value based on the vehicle mass value, driving/braking torque, and the angular wheel velocity value; set the driving resistance force value to the estimated driving resistance force value; in response to a determination that the vehicle mass value is convergent, determine a fuel level value and a seat occupancy value for at least one seat of an associated vehicle; estimate, using the fuel level value and the seat occupancy value, a vehicle load value; and set, based on the vehicle load value, at least one of a center of gravity value of the vehicle and a moment of inertia value of the vehicle.

In some embodiments, the instructions further cause the processor to estimate the driving resistance force value using a recursive least square function. In some embodiments, the instructions further cause the processor to determine the seat occupancy value for at least one seat; including using data associated with at least one corresponding seatbelt sensor. In some embodiments, the instructions further cause the processor to estimate, in response to a determination that the longitudinal acceleration value is greater than the minimum threshold and in response to the longitudinal acceleration value being within an acceleration range, a vehicle mass value based on the estimated driving resistance force value and set the vehicle mass value to the estimated vehicle mass value. In some embodiments, the instructions further cause the processor to, in response to a determination that the vehicle mass value is convergent, determine the fuel level value and the seat occupancy value for at least one seat of the associated vehicle, and estimate, using the fuel level value and the seat occupancy value, the vehicle load value. In some embodiments, the instructions further cause the processor to set, based on the vehicle load value, at least one of the center of gravity values of the vehicle and the moment of inertia value of the vehicle. In some embodiments, the instructions further cause the processor to estimate the vehicle mass value using a recursive least square function. In some embodiments, the instructions further cause the processor to determine the seat occupancy value for at least one seat using data associated with at least one corresponding seatbelt sensor. In some embodiments, the instructions further cause the processor to selectively control at least one aspect of a vehicle system of the vehicle using at least one of the center of gravity values of the vehicle and the moment of inertia value of the vehicle.

In some embodiments, an apparatus for vehicle mass estimation includes a processor and a memory. The memory includes instructions that, when executed by the processor, cause the processor to: set a vehicle mass value to an initial value and a driving resistance force value to an initial value; receive at least a longitudinal acceleration value, driving/braking torque on each axle/wheel, and an angular wheel velocity value; in response to the longitudinal acceleration value being less than a threshold: estimate a driving resistance force value based on the estimated vehicle mass value and the angular wheel velocity value; set the driving resistance force value to the estimated driving resistance force value; in response to a determination that the vehicle mass value is convergent, determine a fuel level value and a seat occupancy value for at least one seat of an associated vehicle; estimate, using the fuel level value and the seat occupancy value, a vehicle load value; and set, based on the vehicle load value, at least one of a center of gravity value of the vehicle and a moment of inertia value of the vehicle; in response to a determination that the longitudinal acceleration value is greater than the minimum threshold and in response to the longitudinal acceleration value being within an acceleration range: estimate a vehicle mass value based on the estimated driving resistance force value and set the vehicle mass value to the estimated vehicle mass value; in response to a determination that the vehicle mass value is convergent, determine the fuel level value and the seat occupancy value for at least one seat of the associated vehicle; and estimate, using the fuel level value and the seat occupancy value, the vehicle load value; and selectively control at least one aspect of a vehicle system of the vehicle using at the at least one of the center of gravity value of the vehicle and the moment of inertia value of the vehicle.

In some embodiments, the instructions further cause the processor to estimate the driving resistance force value and the vehicle mass value using a recursive least square function.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as an “example” is not necessarily to be construed as preferred or advantageous over other aspects or designs. Rather, the use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, the use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application-specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for vehicle mass estimation, the method comprising:
setting a driving resistance force value to an initial value;
receiving at least a longitudinal acceleration value and an angular wheel velocity value;
estimating, in response to the longitudinal acceleration value being less than a threshold, an estimated driving resistance force value based on an estimated vehicle mass value and the angular wheel velocity value;
setting the driving resistance force value to the estimated driving resistance force value;
in response to a determination that the vehicle mass value is convergent, determining a fuel level value and a seat occupancy value for at least one seat of an associated vehicle;
estimating, using the fuel level value and the seat occupancy value, a vehicle load value; and
setting, based on the vehicle load value, at least one of a center of gravity values of the vehicle and a moment of inertia value of the vehicle.

2. The method of claim 1, wherein estimating the estimated driving resistance force value includes using a recursive least square function.

3. The method of claim 1, wherein determining the seat occupancy value for at least one seat includes using data associated with at least one corresponding seatbelt sensor.

4. The method of claim 1, further comprising estimating, in response to a determination that the longitudinal acceleration value is greater than the threshold and in response to the longitudinal acceleration value being within an acceleration range, an estimated vehicle mass value based on the driving resistance force value and setting the vehicle mass value to the estimated vehicle mass value.

5. The method of claim 4, further comprising:
in response to a determination that the vehicle mass value is convergent, determining the fuel level value and the seat occupancy value for at least one seat of the associated vehicle; and
estimating, using the fuel level value and the seat occupancy value, the vehicle load value.

6. The method of claim 5, further comprising setting, based on the vehicle load value, at least one of the center of gravity values of the vehicle, and the moment of inertia value of the vehicle.

7. The method of claim 5, wherein estimating the vehicle mass value includes using a recursive least square function.

8. The method of claim 5, wherein determining the seat occupancy value for at least one seat includes using data associated with at least one corresponding seatbelt sensor.

9. The method of claim 1, further comprising selectively controlling at least one aspect of a vehicle system of the vehicle using at least one of the center of gravity values of the vehicle and the moment of inertia value of the vehicle.

10. A system for vehicle mass estimation, the system comprising:
a processor; and
a memory including instructions that, when executed by the processor, cause the processor to:
set a driving resistance force value to an initial value;
receive at least a longitudinal acceleration value and an angular wheel velocity value;
estimate and set, in response to the longitudinal acceleration value being less than a threshold, the driving resistance force value based on an estimated vehicle mass value and the angular wheel velocity value;
in response to a determination that the vehicle mass value is convergent, determine a fuel level value and a seat occupancy value for at least one seat of an associated vehicle;
estimate, using the fuel level value and the seat occupancy value, a vehicle load value; and
set, based on the vehicle load value, at least one of a center of gravity values of the vehicle and a moment of inertia value of the vehicle.

11. The system of claim 10, wherein the instructions further cause the processor to estimate the driving resistance force value using a recursive least square function.

12. The system of claim 10, wherein the instructions further cause the processor to determine the seat occupancy value for the at least one seat includes using data associated with at least one corresponding seatbelt sensor.

13. The system of claim 10, wherein the instructions further cause the processor to estimate, in response to a determination that the longitudinal acceleration value is greater than the threshold and in response to the longitudinal acceleration value being within an acceleration range, an estimated vehicle mass value based on the estimated driving resistance force value and set the vehicle mass value to the estimated vehicle mass value.

14. The system of claim 13, wherein the instructions further cause the processor to:
in response to a determination that the vehicle mass value is convergent, determine the fuel level value and the seat occupancy value for at least one seat of the associated vehicle; and
estimate, using the fuel level value and the seat occupancy value, the vehicle load value.

15. The system of claim 14, wherein the instructions further cause the processor to set, based on the vehicle load value, at least one of the center of gravity values of the vehicle and the moment of inertia value of the vehicle.

16. The system of claim 14, wherein the instructions further cause the processor to estimate the vehicle mass value using a recursive least square function.

17. The system of claim 14, wherein the instructions further cause the processor to determine the seat occupancy value for at least one seat using data associated with at least one corresponding seatbelt sensor.

18. The system of claim 10, wherein the instructions further cause the processor to selectively control at least one aspect of a vehicle system of the vehicle using at least one of the center of gravity values of the vehicle and the moment of inertia value of the vehicle.

19. An apparatus for vehicle mass estimation, the apparatus comprising:
a processor; and
a memory including instructions that, when executed by the processor, cause the processor to:
set a vehicle mass value to an initial value and a driving resistance force value to an initial value;
receive at least a longitudinal acceleration value and an angular wheel velocity value;
in response to the longitudinal acceleration value being less than a threshold:
estimate a driving resistance force value based on the estimated vehicle mass value and the angular wheel velocity value;
set the driving resistance force value to the estimated driving resistance force value;
in response to a determination that the vehicle mass value is convergent, determine a fuel level value and a seat occupancy value for at least one seat of an associated vehicle;
estimate, using the fuel level value and the seat occupancy value, a vehicle load value; and
set, based on the vehicle load value, at least one of a center of gravity value of the vehicle and a moment of inertia value of the vehicle;
in response to a determination that the longitudinal acceleration value is greater than the threshold and in response to the longitudinal acceleration value being within an acceleration range:
estimate a vehicle mass value based on the driving resistance force value and set the vehicle mass value to the estimated vehicle mass value;
in response to a determination that the vehicle mass value is convergent, determine the fuel level value and the seat occupancy value for at least one seat of the associated vehicle; and
estimate, using the fuel level value and the seat occupancy value, the vehicle load value; and
selectively control at least one aspect of a vehicle system of the vehicle using the at least one center of gravity value of the vehicle and the moment of inertia value of the vehicle.

20. The apparatus of claim 19, wherein the instructions further cause the processor to estimate the estimated driving resistance force value and the estimated vehicle mass value using a recursive least square function.
